(19) United States
(12) Patent Application Publication
(10) Pub. No.: US 2024/0154889 A1
(43) Pub. Date: May 9, 2024

(54) TRAFFIC FLUCTUATION PREDICTION DEVICE,TRAFFIC FLUCTUATION PREDICTION METHOD,AND TRAFFIC FLUCTUATION PREDICTION PROGRAM

(71) Applicant: Nippon Telegraph and Telephone Corporation, Tokyo (JP)

(72) Inventors: Yitu WANG, Musashino-shi, Tokyo (JP); Takayuki NAKACHI, Musashino-shi, Tokyo (JP)

(21) Appl. No.: 18/272,174

(22) PCT Filed: Jan. 20, 2021
(86) PCT No.: PCT/JP2021/001873

§ 371 Date: Jul. 13, 2023

(51) Int. Cl. H04L 43/062; H04L 43/067

(52) U.S. Cl. CPC H04L 43/062; H04L 43/067

(57) ABSTRACT

A data accumulation unit that acquires traffic data of a network obtained in time series and creates a plurality of data sets having different time intervals, a training unit that evaluates a correlation between the plurality of data sets by a plurality of latent functions and calculates a weight coefficient, and a prediction unit that calculates a predicted average using the latent functions calculated by the training unit and predicts network traffic of a future time scale are included.

### [TECHNICAL FIELD]

The present invention relates to a traffic fluctuation prediction device, a traffic fluctuation prediction method, and a traffic fluctuation prediction. program.

### [BACKGROUND ART]

While various kinds of information. communication for the Internet of Things (IoT) are being performed, the characteristics of communication traffic in a network greatly vary with time. In such a situation, there is a demand. for technology for predicting unsteady traffic fluctuation with. high accuracy over a long period of time. As a method of predicting traffic fluctuation, methods disclosed in Non

Patent Literature 1 and 2 are known. Non Patent Literature I discloses predicting traffic fluctuation using the autoregressive integrated moving average (ARIMA) model based on the probability process theory.

Further, Non Patent Literature 2 discloses predicting traffic fluctuation by adopting a random connection long short term memory (LSTM) based on deep learning.

### [Citation List]

### [Non Patent Literature]

[NPL 1] B. Zhou, “Network traffic modeling and prediction with ARIMA/GARCH,” Proc. of HET-NETs, 2005.

[NPL 2] Y. Hua, Z “Deep learning with long short-term memory for time series prediction,” IEEE Commun. Mag., Jun. 2019.

### [SUMMARY OF INVENTION]

### [Technical Problem]

However, in the above-described. Non Patent Literature 1, it is necessary to determine a large number of parameters for ARIMA model selection, and determination of the parameters greatly depends on the experience and discretion. of an analyst, and thus it is hot easy to maintain high. prediction accuracy.

In Non Patent Literature 2, it is necessary to frequently change parameters during learning in order to follow unsteady network traffic which greatly fluctuates with the elapse of time. Since a large amount of data is required for learning, it is difficult to improve parameter estimation accuracy.

The present invention has been made in view of the above circumstances, and an object of the present invention is, to provide a. traffic fluctuation prediction device, a traffic fluctuation prediction method, and a traffic fluctuation prediction program capable of predicting traffic fluctuation with. a small amount of data. and high. accuracy.

### [Solution to Problem]

A traffic fluctuation prediction device of one aspect of the present invention includes a data accumulation unit configured to acquire traffic data of a network obtained in time series and to create a plurality of data sets having different time intervals, a training unit configured to evaluate a correlation between the plurality of data sets by a plurality of latent functions and. to calculate a weight coefficient,, and. a prediction unit configured to calculate a predicted average by the latent functions using the weight coefficient calculated by the training unit and to predict network traffic of a future time scale.

A traffic fluctuation prediction method of one aspect of the present invention includes a step of acquiring traffic data of a network obtained in time series and creating a plurality of data sets having different time intervals, a step of evaluating a correlation between. the plurality of data sets by a plurality of latent functions and calculating a weight coefficient, and a step of calculating a predicted average by the latent functions using the weight coefficient and predicting network traffic of a future time scale.

One aspect of the present invention is a traffic fluctuation prediction program for causing a computer to serve as the aforementioned traffic fluctuation prediction device.

### [Advantageous Effects of Invention]

According to the present invention, it is possible to predict traffic fluctuation with a small amount of data and high accuracy.

### [BRIEF DESCRIPTION OF DRAWINGS]

[FIG. 1]

FIG. 1 is a block diagram showing a configuration of a traffic fluctuation prediction device according to an embodiment of the present invention.

[FIG. 2]

FIG. 2 is an explanatory diagram showing a procedure of acquiring traffic data.

[FIG. 3]

FIG. 3 is a transition diagram showing processing of the traffic fluctuation prediction device.

[FIG. 4]

FIG. 4 is a graph showing true values, predicted values, and a 95% confidence region of traffic.

[FIG. 5]

FIG. 5 is a graph showing changes in RMSE and a training time with respect to changes in a predicted time.

[FIG. 6]

FIG. 6 is a. graph showing changes in. RMSE and a. training time with respect to changes in the number of pieces of training data.

[FIG. 7]

FIG. 7 is a block diagram showing a hardware configuration.

### [DESCRIPTION OF EMBODIMENTS]

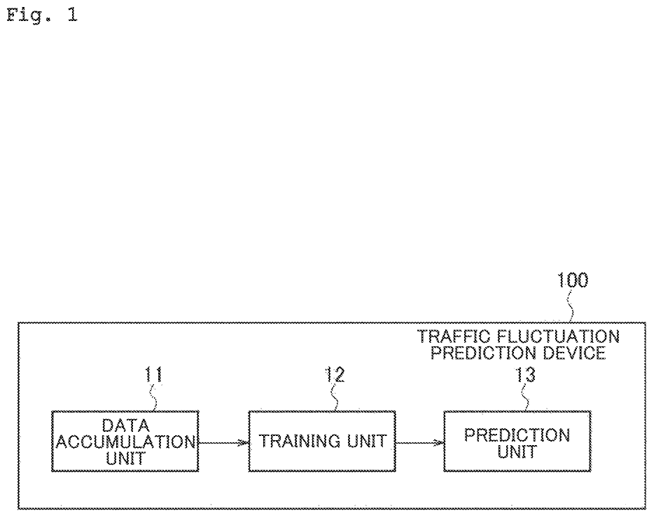

Embodiments of the present invention will be described below. FIG. 1 is a block diagram showing a configuration of a traffic fluctuation prediction. device according to the present embodiment. As shown in FIG. 1, the traffic fluctuation prediction device 100 according to the present embodiment includes a data accumulation. unit 11, a training unit 12, and a prediction. unit 13.

In the traffic fluctuation prediction device 100 according, to the present embodiment, traffic of N future slots is predicted. on the basis of traffic data information of N past finite time slots. At this time, a time-series signal of the traffic is defined as represented by the following formula. (1).

[Math. 1]

{(t−M), y(t−M+1), . . . , y(t), y(t+1), . . . , y(t+N−1)} (1)

In the present embodiment, traffic of N future slots is predicted in. M time slots t, and. the time average of prediction errors is minimized. That is, an output “y\hat{ }” for minimizing the numerical value represented. by the following formula (2).

$$\begin{matrix}[ Math . 2 ] & \\ {min}_{\hat{y} ( t ) , ⋯ , \hat{y} ( t + N - 1 )} {𝔼}_{t} [ {\sum }_{i = 0}^{N - 1} \vert \hat{y} ( t + i ) - y ( t + i ) \vert ] \\ wherein \hat{y} ( t + i ) = {h}_{i} ( y ( t - M ) , ⋯ , y ( t - 1 ) ) & ( 2 )\end{matrix}$$

Provided that hi (.) indicates a prediction function of an i-th future slot. In addition, “Et” indicates an expected value.

### [Processing of Data Accumulation Unit. 11]

The data accumulation unit 11 acquires traffic data of a network obtained. in time series and creates a plurality of data sets having different time intervals. When network traffic (hereinafter referred to as “NW traffic”) of M past time slots is obtained, the data accumulation unit 11 generates N training data. sets “Di” having different time scales as represented by the following formula (3). Note that “i” indicates the size of training data. “X” indicates an input represented. by formula (5) which will be described.

later. “P” indicates a traffic sample.

[Math. 3]

Dᵢ={X, Pᵢ}, i ∈ {1, 2, . . . , N} (3)

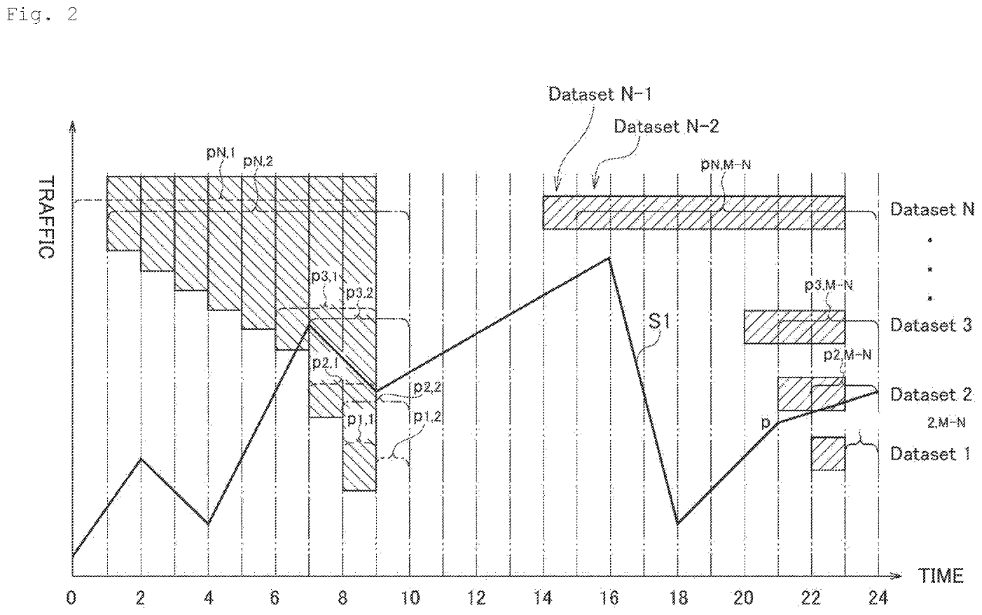

FIG. 2 is an explanatory diagram showing a process of calculating “Dataset1” to “DatasetN” by aggregating traffic samples. In FIG. 2, the horizontal axis represents time and the vertical axis represents traffic. Further, the curve S1 indicates fluctuation of NW traffic.

For example, in FIG. 2, a. time slot is defined. such that time 0 to time 1 is defined as a time slot t0, time 1 to time 2 is defined as a time slot t2, and so on. Each. time slot is a time in the past. The first element “DatasetN-1” of DatasetN is calculated on the basis of each piece of traffic data in a time slot of t0 to t9 (indicated by “p_N, 1” in. the figure).

Further, the second element “DatasetN-2” of DatasetN is calculated on the basis of each piece of traffic data in. a time slot of t1 to t10 (indicated by “p_N, 2”) obtained by sliding the time slot to the right side by one. By repeating this operation N times, each element (referred to as “sliding window”) of “DatasetN” is calculated.

A j-th traffic sample “pi,j” in an i-th Lime scale in the sliding window can be calculated by the following formula (4).

$$\begin{matrix}[ Math . 4 ] & \\ {p}_{i , j} = {\sum }_{k = 1}^{i} y ( t - ( M - N ) - k + j ) , j ∈ \{ 1 , 2 , ⋯ , M - N \} & ( 4 )\end{matrix}$$

Provided. that “M-N” indicates the number of traffic samples in a data set.

As described above, the data accumulation unit 11 can acquire N data sets “Dataset1” to “DatasetN.”

### [Processing of Training Unit 12]

The training unit 12 shown in FIG. 1 evaluates the correlation between the plurality of data sets by a plurality of latent functions to calculate a weight coefficient. That is, the training . unit 12 evaluates the correlation. between. the N data. sets using a plurality of latent functions g (x) and calculates and updates a weight coefficient wq. The prediction accuracy is improved by updating the weight coefficient wq.

Processing of the training unit 12 will he described in detail below. First, a Gaussian process will be described as prerequisite knowledge. A regression model of an input X and an output Y represented by the following formula (5) is conceivable.

[Math. 5]

X={x₁, . . . , x_{M}} Y={y₁, . . . , y_{M}} (5)

When the input H is applied, the output Y can be represented by the following formula (6).

[Math. 6]

Y=f(X)+ε (6)

Here, “ε” is Gaussian noise having an average of zero and complying with dispersion “σ 2,” and “f(·)” is a mapping function. of X and Y based on. Gaussian distribution represented by the following formula (7).

[Math. 7]

f(X)˜ [symbol] (m(X), K(X, X)) (7)

The mapping function represented by the formula (7) corresponds to linear and non-linear, “m(X)” is an average function (normally set to zero) , and “K(X, X)” is a covariance function called a kernel function.

Processing of the training unit 12 is to predict corresponding out-out “y*” when a new input. “x*” is obtained (where “x*” is not in included in. X). At this time, the simultaneous distribution of Y and f following formula (8).

$$\begin{matrix}[ Math . 8 ] & \\ [ \begin{matrix}Y \\ f ( {x}^{*} )\end{matrix} ] ∼ 𝒩 ( [ \begin{matrix}0 \\ 0\end{matrix} ] , [ \begin{matrix}K ( X , X ) + {σ}^{2} I & K ( X , {x}^{*} ) \\ K ( {x}^{*} , X ) & K ( {x}^{*} , {x}^{*} )\end{matrix} ] ) & ( 8 )\end{matrix}$$

However, “K(X, X) in formula (8) is a symmetric positive semi-definiteness (PSD) covariance matrix whose elements are given by “Ki,j=K(xi;xj)”. The symbol “˜” indicated in formula (8) means that the left side follows the distribution of the right side.

Further, “I” represented in formula (8) is a unit matrix. “K(X,x*) (=K*)” indicates a covariance M learning inputs “X” and new input “x*.” Since the conditional probability distribution of “f(x*)” when “X,” “Y,” and are given is obtained from a conditional probability between elements of the Gaussian distribution, it can be represented by the following formula (9).

[Math. 9]

p(f(X*)|(X, Y, x*))˜ [symbol] (\hat{f}(x*), σ²(x*)) (9)

However, the predicted average and the variance are calculated as represented by the following formula (10).

[Math. 10]

\hat{f}(x*)=K_{*}^{T}(K(X, X)+σ²I)⁻¹Y (10)

σ²(x*)=K(x*,X*)−K_{*}^{T}(K(X, X)+σ²I)⁻¹Y

The variance “Γ2” and a hyperparameter of the kernel function are determined by minimizing the negative logarithmic peripheral likelihood. That is, they are calculated by the following formula (11).

$$\begin{matrix}[ Math . 11 ] & \\ {min}_{K , σ} {{Y}^{T} ( K ( X , X ) + {σ}^{2} I )}^{- 1} Y + {log}_{2} \vert K ( X , X ) + {σ}^{2} I \vert . & ( 11 )\end{matrix}$$

This can be efficiently obtained by the steepest descent method (gradient method) using partial derivative of the peripheral likelihood for the hyperparameter.

A kernel function for mixing Gaussian distributions in the frequency domain can be represented by the following formula (12).

$$\begin{matrix}[ Math . 12 ] & \\ K ( {x}_{i} , {x}_{j} ) = {\sum }_{q = 1}^{Q} {ω}_{q} {e}^{- 2 {πτ}_{p}^{2} {v}_{q}} cos ( 2 {πτμ}_{q} ) & ( 12 )\end{matrix}$$

In formula (12), “τ=xi−xj (i>j)” is the distance between “xi” and “xj” Q represents the number of mixed components, the average of the q-th component is “μq” and the covariance is “vq.” If sufficient mixed components are given in the frequency domain, an arbitrary steady kernel function can be approximated with arbitrary accuracy.

The kernel function of formula (12) has a high expressive power and is adapted. to the characteristics of a training data set using a trained spectral density. The weight “ωq” indicates a relative contribution of each mixed component, and. the inverse average “1/μq” indicates the period. of the components. The inverse standard deviation “1/vq” is a hyperparameter that determines a speed of adapting to the training data set.

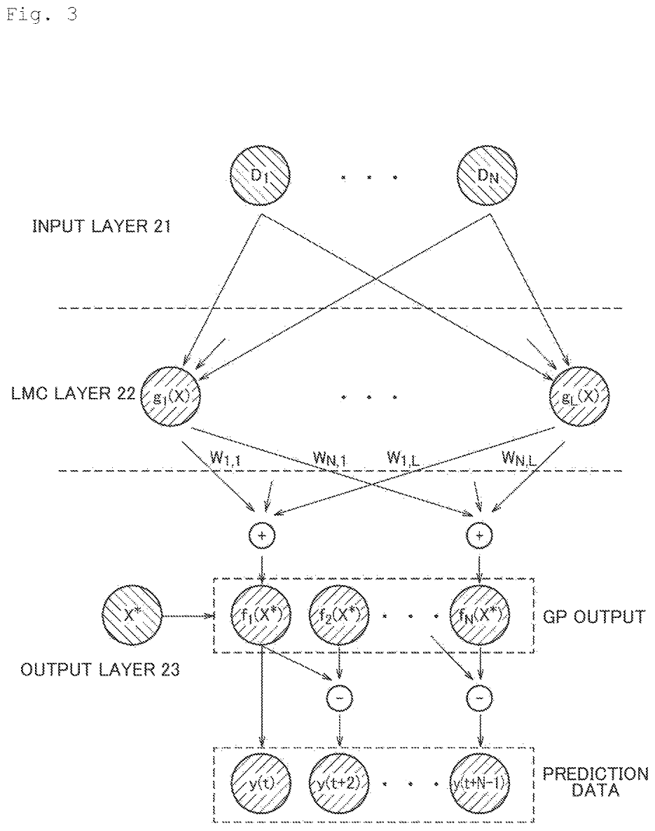

FIG. 3 is a. diagram showing a multi-scale learning framework based on a Gaussian process. As shown in FIG. 3, the learning framework includes an input layer 21, an LMC layer 22, and. an output layer 23.

As represented by the following formula (13), when N new inputs “X*” are given is the input layer 21, N corresponding outputs “P” are estimated. D1 to DN represented in the input layer 21 indicate “Dataset1” to “DatasetN” shown in FIG. 2.

[Math. 13]

X*={xₙ^{*}|n ∈ {1, . . . , N}} (13)

P*={pₙ^{*}|n ∈ {1, . . . , N}}

The simultaneous distribution. of “X*” and “P*” represented by the aforementioned formula (13) can be expressed by the following formula (14).

$$\begin{matrix}[ Math . 14 ] & \\ [ \begin{matrix}P \\ f ( {X}^{*} )\end{matrix} ] ∼ 𝒩 \{ [ \begin{matrix}0 \\ 0\end{matrix} ] , [ \begin{matrix}K ( X , X ) + {σ}^{2} I & K ( X , {X}^{*} ) \\ K ( {X}^{*} , X ) & K ( {X}^{*} , {X}^{*} )\end{matrix} ] ) & ( 14 )\end{matrix}$$

Here, is order to calculate “K(X*, X*)” and “K(X*, X)” represented in formula (14) using as output correlation, a linear model of collisionalization (hereinafter referred to as “LMC”) is adopted. In LMC, the output is represented as a linear combination. of latent functions “gn(X*)” as represented by the following formula (15). The LMC layer 22 executes an operation according to the following formula (15).

$$\begin{matrix}[ Math . 15 ] & \\ {f}_{n} ( {X}^{*} ) = {\sum }_{l = 1}^{L} {w}_{n , l} {g}_{n} ( {X}^{*} ) & ( 15 )\end{matrix}$$

The latent function “gn(X*)” represented by formula (15) is assumed to be zero on average and to be a Gaussian process of a covariance represented by the following formula (16).

[Math. 16]

cov(gₙ(xᵢ*), gₙ(xⱼ*, xⱼ*) (16)

“Wn,1” represented in formula (15) is a weight coefficient of the I-th latent function and the n-th output.

Kernel functions associated with respective latent functions are designed to have different hyperparameters such that the latent functions can represent various characteristics of traffic time series. A new kernel function based on LMC can be represented by the following formula (17).

$$\begin{matrix}[ Math . 17 ] & \\ K ( {x}_{i} , {x}_{j} ) = \{ \begin{matrix}K ( {x}_{i} , {x}_{j} ) , {x}_{i} , {x}_{j} ∈ X \\ {\sum }_{l = 1}^{L} {w}_{i , l} {w}_{j , l} {K}_{l} ( {x}_{i} , {x}_{j} ) , {x}_{i} , {x}_{j} ∈ {X}^{*} \\ {\sum }_{l = 1}^{L} {w}_{i , l} {K}_{l} ( {x}_{i} , {x}_{j} ) , {x}_{i} ∈ {X}^{*} , {x}_{j} ∈ X .\end{matrix} & ( 17 )\end{matrix}$$

The kernel function represented. by formula (17) is generated by linearly combining several PSD kernel functions, and the resulting function is also a PSD kernel function. Further, it is ascertained that a correlation between output signals is reflected in. the PSD kernel function. through. a weight coefficient “wn,1”. Data of the latent function “gn(X*)” is output to the output layer 23 shown in FIG. 3.

### [Processing of Prediction Unit 13]

Next, the prediction unit 13 shown in FIG. 1 will be described. The prediction unit 13 calculates a predicted average by a latent function using a weight coefficient calculated by the training unit 12 and predicts network traffic of a future time scale. That is, the prediction unit. 13 obtains the predicted average f(x*) indicated in the output layer 23 of FIG. 3 using the latent function “gn(X*)” obtained. by the training unit 12 and predicts NW traffic of N future time scales (slots).

The predicted. average and variance can be calculated by the aforementioned formula (8). This calculation is performed by GP output of the output layer 23 shown in FIG. 3. After the predicted average “f\hat{ } ” and the variance “σ2” are calculated, traffic of N future slots can be predicted by the following formula (18).

$$\begin{matrix}[ Math . 18 ] & \\ \tilde{y} ( t + i ) = \{ \begin{matrix}{\hat{f}}_{i + 1} ( {X}^{*} ) , i = 0 \\ {\hat{f}}_{i + 2} ( {X}^{*} ) - {\hat{f}}_{i + 1} ( {X}^{*} ) , i ∈ \{ 1 , 2 , ⋯ , N - 1 \}\end{matrix} & ( 18 )\end{matrix}$$

### [Description of Simulation Results]

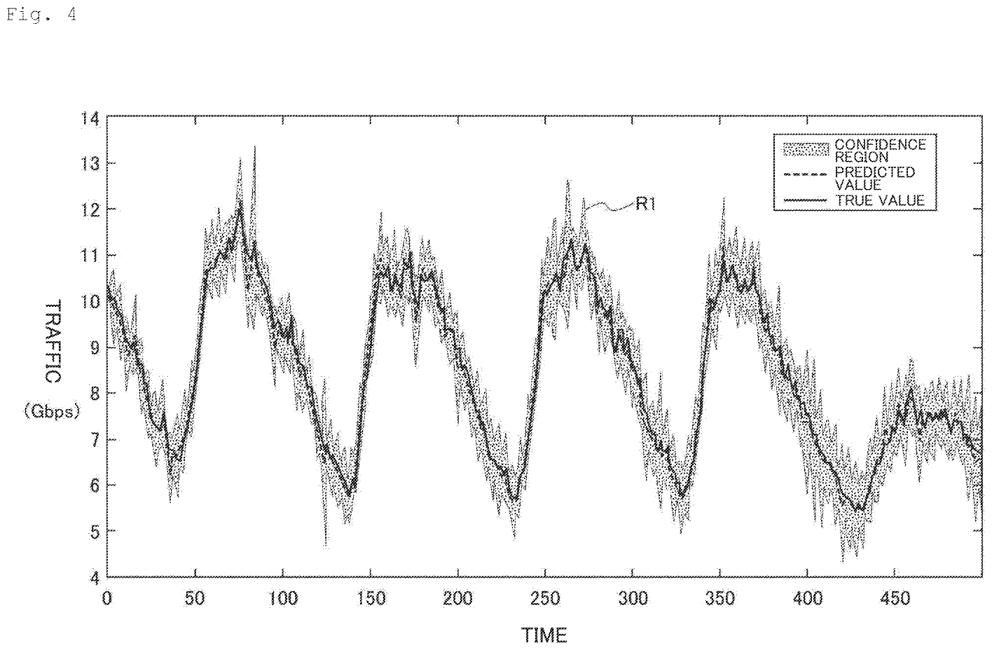

FIG. 4 is a graph showing traffic fluctuation prediction results when the traffic fluctuation prediction device 100 according to the present embodiment is used. In FIG. 4, the horizontal axis represents time and the vertical axis represents traffic. solid line indicates a true value of traffic, and. a broken line indicates a predicted value of traffic In addition, a region R1 indicates a 95% confidence region. It is understood from the graph shown in FIG. 4 that traffic fluctuation can be predicted with extremely high accuracy by using the traffic fluctuation prediction device 100 according the present embodiment.

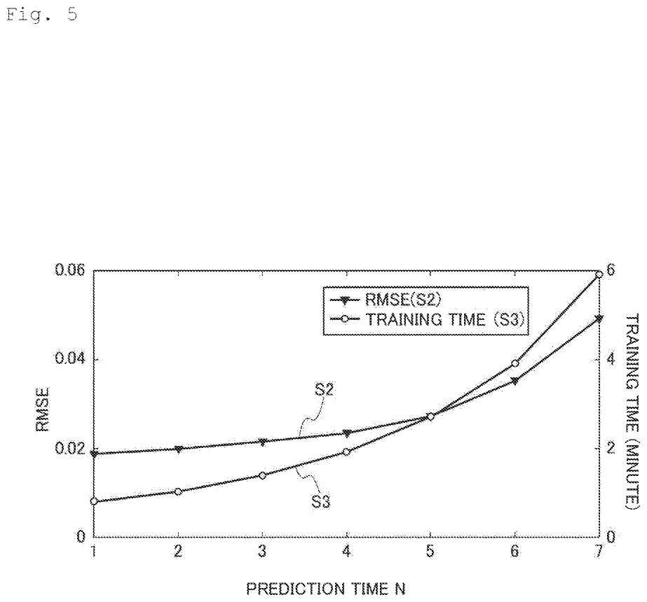

FIG. 5 is a graph showing a relationship between root mean square error (RMSE) and a training time with respect to change in a prediction time when the traffic fluctuation prediction device 100 according to the present embodiment is used. FIG. 5, a curve 52 indicates RMSE and a curve S3 indicates the training time.

As shown in FIG. 5 it is generally recognized that the prediction accuracy is reduced according to an increase in the prediction time “N,” but it is understood that an increase rate of RMSE is reduced when “N<6” by utilizing the output correlation. That is, error is small and high prediction accuracy is maintained.

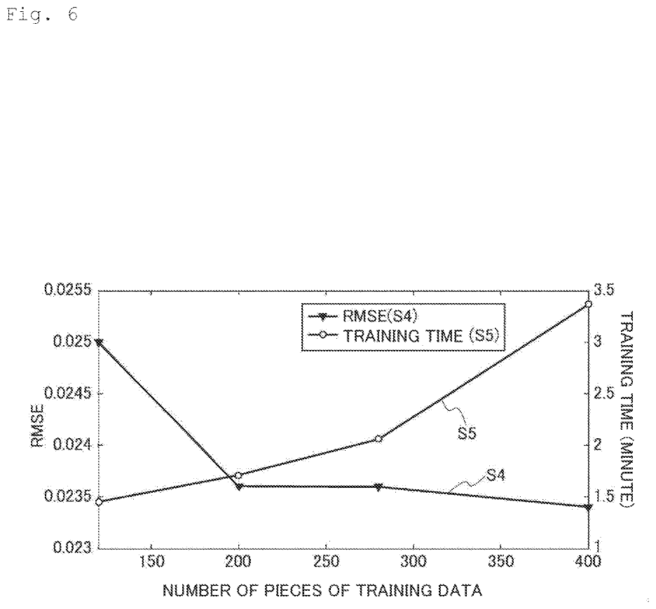

FIG. 6 is a graph showing a relationship between RMSE and a training time with respect to change in the number of pieces of training data when the traffic fluctuation prediction device 100 according to the present embodiment is used. In FIG. 5, a curve S4 indicates RMS and a curve 55 indicates the training time.

As shown in FIG. 6, the larger the number of pieces of training data, the smaller the error is in the present embodiment. On the other hand, it is understood that even when the number of pieces of training data is small, high prediction performance is maintained.

### [Effects of Present Embodiment]

In this manner, the traffic fluctuation prediction device 100 of the present embodiment includes the data accumulation unit 11 that acquires traffic data of a network obtained in time series and creates a plurality of data sets having different time intervals, a training unit 12 that evaluates a correlation between the plurality of data sets using a. plurality of latent functions g(x) and calculates a weight coefficient wq, and a prediction unit 13 that calculates a predicted average. f(x) by the latent functions g(x) using the weight coefficient wq calculated by the training unit 12 and predicts network traffic of a future time scale (slot).

Therefore, it is possible to follow long-term and sudden changes in observed signal characteristics with respect to unsteady traffic fluctuation and to achieve highly accurate traffic prediction. with a. small amount of data.

Further, in the present embodiment, it is possible to follow long-term. and sudden traffic fluctuation by constructing a prediction model based on a Gaussian process and using, a linear model of collisionalization in combination. Therefore, highly accurate prediction. can. be performed as compared to support vector regression (SVR), ARIMA based on probability process theory, LSTM based on deep learning, RCLSTM, and the like which have been. conventionally adopted.

Further, in the present embodiment, an arbitrary steady kernel function can be approximated with arbitrary accuracy by using a kernel function for mixing Gaussian distributions in the frequency domain. Accordingly, it is possible to self-adaptively learn. characteristics of network traffic from. various times and time scales by adaptively adjusting hyperparameters associated with the number of mixed components.

In addition, in order to reduce an increment of a prediction error when a prediction time is long, an integrated prediction model can be established. to achieve. higher prediction accuracy by adopting a linear model of collisionalization which represents an output as a linear combination of a plurality of latent functions to utilize an output correlation.

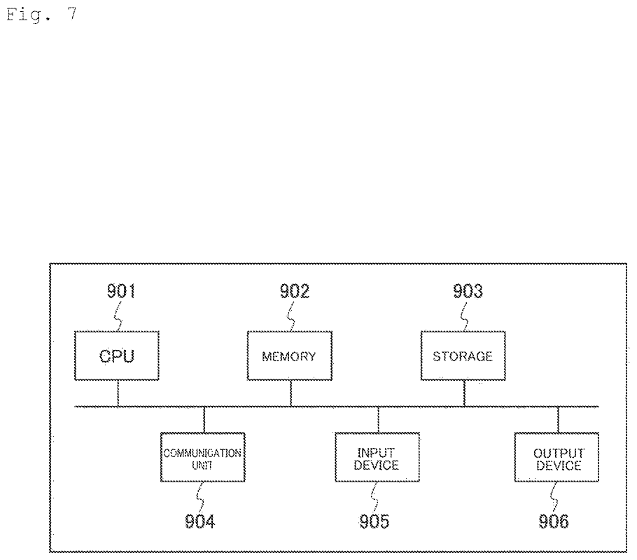

For the traffic fluctuation prediction device 100 of the present embodiment described above, a general-purpose computer system including, for example, a central processing unit (CPU, processor) 901, a memory 902, a storage 903 (hard disk drive (HDD) or a solid state drive (SSD)), a communication device 904, an input device 905, and an output device 906, as shown in FIG. 7, can be used. The memory 02 and the storage 903 are storage devices. In this computer system, each function of the traffic fluctuation prediction device 100 is realized by the CPU 901 executing a predetermined program loaded on the memory 902.

The traffic fluctuation prediction device 100 may be implemented by one computer or may be implemented by a plurality of computers. Further, the traffic fluctuation prediction device 100 may be a virtual machine implemented on a computer.

A program for the traffic fluctuation prediction device 100 can be stored in a computer-readable recording medium such as an HDD, an SSD, a Universal Serial Bus (USB) memory, a compact disc (CD), or a. digital versatile disc (DUD), or can. be distributed via a network.

The present invention is not limited by the above embodiments, and numerous modifications are available within the scope and gist of the invention.

### [Reference Signs List]

11 Data accumulation unit
12 Training unit
13 Prediction unit
21 Input layer
22 LMC layer
23 Output layer
100 Traffic fluctuation prediction device

1. A traffic fluctuation prediction device comprising a processor configured to execute instructions that cause the traffic fluctuation prediction device to perform operations comprising:
acquiring traffic data of a network obtained in time series and creating a plurality of data sets having different time intervals;
evaluating a correlation between the plurality of data sets by a plurality of latent functions and to calculate calculating a weight coefficient; and
calculating a predicted average by the latent functions using the weight coefficient and predicting network traffic of a future time scale.

2. The traffic fluctuation prediction device according to claim 1, wherein the processor is configured to construct a prediction model based on a Gaussian process and calculate the weight coefficient by using a linear model of collisionalization in combination.

3. The traffic fluctuation prediction device according to claim 1, wherein the processor is configured to use a kernel function for mixing Gaussian distributions in a frequency domain.

4. A traffic fluctuation prediction method comprising:
acquiring traffic data of a network obtained in time series and creating a plurality of data sets having different time intervals;
evaluating a correlation between the plurality of data sets by a plurality of latent functions and calculating a weight coefficient; and
calculating a predicted average by the latent functions using the weight coefficient and predicting network traffic of a future time scale.

5. (canceled)

6. A non-transitory computer storage medium encoded with instructions that, when executed by one or more computers, cause the one or more computers to perform operations comprising:
acquiring traffic data of a network obtained in time series and creating a plurality of data sets having different time intervals;
evaluating a correlation between the plurality of data sets by a plurality of latent functions and calculating a weight coefficient; and
calculating a predicted average by the latent functions using the weight coefficient and predicting network traffic of a future time scale.
